(19) United States
(12) Patent Application Publication
(10) Pub. No.: US 2018/0084738 A1
(43) Pub. Date: Mar. 29, 2018

(54) THREE-DIMENSIONAL DYNAMIC PLANT CULTIVATING APPARATUS AND IMPLEMENTING METHOD THEREOF

(71) Applicant: Shu-Shyang Kuo, Taipei City (TW)

(72) Inventor: Shu-Shyang Kuo, Taipei City (TW)

(21) Appl. No.: 15/280,299

(22) Filed: Sep. 29, 2016

(51) Int. Cl. A01G 9/26; A01G 1/00; A01G 7/04; A01G 13/02; A01G 9/12; A01G 9/16; A01G 9/24

(52) U.S. Cl. CPC A01G 9/26; A01G 1/001; A01G 7/045; A01G 13/0243; A01G 13/0206; A01G 9/16; A01G 9/243; A01G 9/247; A01G 9/245; A01G 9/12

(57) ABSTRACT

A three-dimensional dynamic plant cultivating apparatus for plant cultivation mainly has an outer cover and a supporting member disposed in the outer cover and surrounded by a rail module. The rail module is further assembled with supporting plates for supporting a plant pot. Upon implementation of the invention, the rail module operates along a periphery of the supporting member, so that the plant pot can circulate upwards and downwards around the supporting member repeatedly and can be subjected to overall irradiation of a sun light source to contribute to growth of the planted material. Furthermore, a plant cultivating device, an illumination device and sensors are further connected together in the outer cover to form a timing-controlled and quantitative automatic cultivation environment advantageous to prompting of the growth of the planted material.

### BACKGROUND OF THE INVENTION

### (1) Field of the Invention

The invention relates in general to a three-dimensional dynamic plant cultivating apparatus, and more particularly to a three-dimensional dynamic plant cultivating apparatus, in which a plant pot can be subjected to overall irradiation of a sun light source through a rail module capable of circulating upwards and downwards around a supporting member.

### (2) Description of the Prior Art

The conventional plant cultivation is mainly the open type cultivation, which tends to be affected by the weather. When the typhoon season comes, the open farmland is directly attacked, and the agricultural production and quality cannot be easily controlled. An existing plant cultivation method adopts the “greenhouse cultivation”. The conventional greenhouse can provide the better cultivation environment, and cannot be easily affected by the climate change either. However, the greenhouse cultivation has the higher requirement on the land. In order to increase the usage of the land cultivation, some farmers install multi-layer placement shelves in the greenhouse to increase the spatial usage through the laminated cultivation. However, the plants on the bottom layer of the placement shelf may be affected by the change of the sunshine angle, so that the plants on the layers have the differences between the light receiving levels, and thus have different cultivation qualities, which are not the poor results to the farmers. Thus, how to make the plants in the greenhouse receive the uniform sunshine is a problem to be solved.

### SUMMARY OF THE INVENTION

In view of the above-mentioned problems and requirements, the present inventor has paid attention to the analysis and research of improving the plant growth environment and the greenhouse structure according to the experience of the associated greenhouse cultivation for many years, and wishes to design the physical product for solving the above-mentioned problems. Therefore, a main object of the invention is to provide a three-dimensional dynamic plant cultivating apparatus of providing uniform irradiation to plants planted in a greenhouse, and further automatically controlling peripheral cultivating apparatuses to achieve the timing-controlled and quantitative requirements.

To achieve the above-identified object, the invention provides a three-dimensional dynamic plant cultivating apparatus mainly having an arced cover body, and at least one supporting member disposed in the arced cover body. In addition, a rail module is disposed to surround the supporting member. In this invention, the rail module is mainly driven by a control device, so that the rail module can continuously circulate upwards and downwards around the supporting member, and thus to move one or multiple supporting plates mounted on the rail module. When a plant pot is placed on the supporting plate, the supporting plate can further circulate the plant pot upwards and downwards around the supporting member, so that each plant pot can be subjected to comprehensive irradiation of a sun light source without being affected by the sun light change. Thus, the plant pots are uniformly subjected to the sufficient irradiation time to facilitate the plant growth. Furthermore, multiple associated cultivating apparatuses (e.g., a watering and irrigating module and a fertilizing module) are disposed in the cover body and automatically controlled by the control device, so that the required nutriment is supplied in a timing-controlled and quantitative manner, and the plant pots have the uniform plant growth environment.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic view showing a three-dimensional structure of the invention.

FIG. 2 is a block diagram showing the invention.

FIG. 3 is a flow chart showing the implementation of the invention.

FIG. 4 is a schematic view showing the implementation of the invention.

FIG. 5 is another schematic view showing the implementation of the invention.

FIG. 6 is still another schematic view showing the implementation of the invention.

FIG. 7 is yet still another schematic view showing the implementation of the invention.

FIG. 8 shows another embodiment of the invention.

FIG. 9 shows still another embodiment of the invention.

### DETAILED DESCRIPTION OF THE PREFERRED EMBODIMENTS

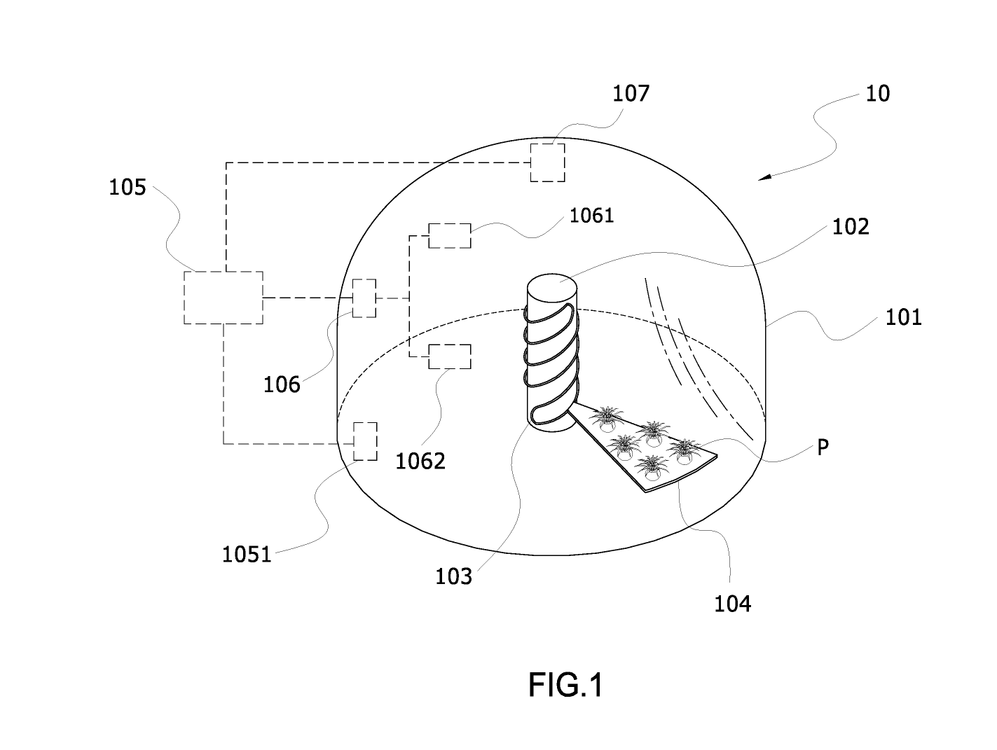

FIG. 1 is a schematic view showing a three-dimensional structure of the invention. Referring to FIG. 1, a three-dimensional dynamic plant cultivating apparatus 10 mainly includes an arced cover body 101 having a transparent surface, through which a light source may be incident to the inside of the cover body 101. The cover body 101 is an airtight space to prevent the insect pest. Also, at least one supporting member 102 stands inside the cover body 101, and one or multiple rail modules 103 surround the supporting member 102 and are disposed around the supporting member 102. In addition, the rail module 103 is assembled with separated supporting plates 104 for supporting one or multiple plant pots, and a control device 105 is electrically connected to the rail module 103. Referring further to this drawing, a plant cultivating device 106 and an illumination device 107 are electrically connected to the control device 105, wherein the plant cultivating device 106 is assembled with an inner wall surface of the cover body 101 and disposed on a path of the rail module 103. Furthermore, the plant cultivating device 106 is composed of at least one watering and irrigating module 1061 and at least one fertilizing module 1062, and the watering and irrigating module 1061 may be an atomizing apparatus or a water spraying apparatus for watering and irrigating the plant. Also, the fertilizing module 1062 may be an automatic fertilizing device for fertilizing the plant. Furthermore, the illumination device 107 is assembled with the top end of the cover body 101, and may be a light-emitting diode (LED) lamp, a daylight lamp or the like.

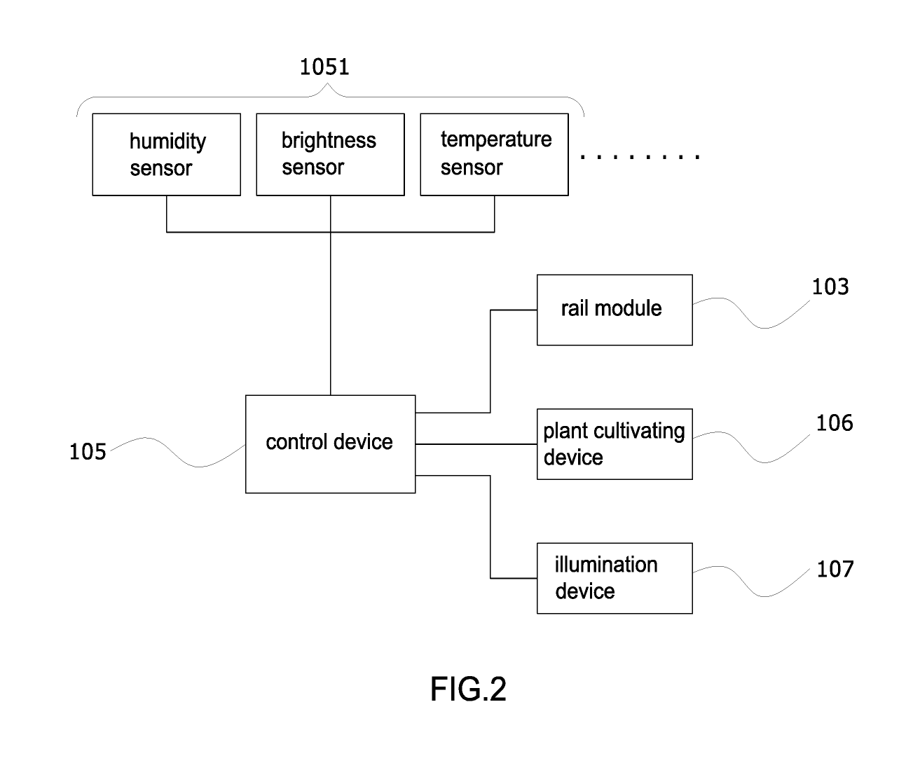

FIG. 2 is a block diagram showing the invention. Referring to FIGS. 2 and 1, as mentioned hereinabove, the control device 105 mainly executes an automatic control procedure on the associated cultivating apparatuses, and may further drive the rail module 103 to make the rail module 103 move and operate and circulate upwards and downwards around the supporting member 102 in a timing-controlled and repeatedly manner. Furthermore, the control device 105 has one or multiple sensing modules 1051 further disposed inside the cover body 101. The sensing module 1051 may be selected from the group consisting of a humidity sensor, a brightness sensor and a temperature sensor. Also, the sensing module 1051 can sense an environment state inside the cover body 101 in a real-time manner, and generate environment state information (e.g., temperature, humidity, luminance and/or the like). When the control device 105 receives the environment state information of the sensing module, the control device 105 further judges the environment state information. When the sensing module 1051 senses the too-low humidity inside the cover body 101, the control device 105 immediately enables the plant cultivating device 106 to perform watering and irrigating on the plant pot supported on the supporting plate 104. If the sun light source has the insufficient intensity so that the illuminance inside the cover body 101 is too low, the control device 105 immediately enables the illumination device 107 to provide the supplemental optical energy for the plant for optical reaction. Furthermore, if the sensing module 1051 is a timer, the control device 105 can set the enabling time of each of the plant cultivating device 106 and the illumination device 107 through the timer in advance, so that the timing-controlled and automatic cultivating operations, such as fertilizing, watering and the like, can be performed, the manpower cost can be decreased, and the artificial handling damage can be avoided.

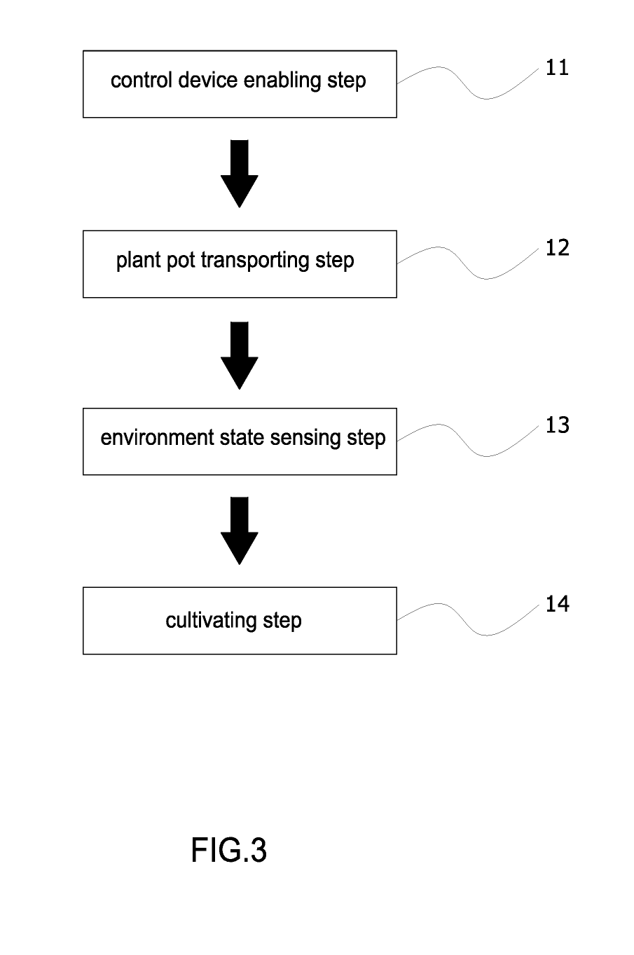

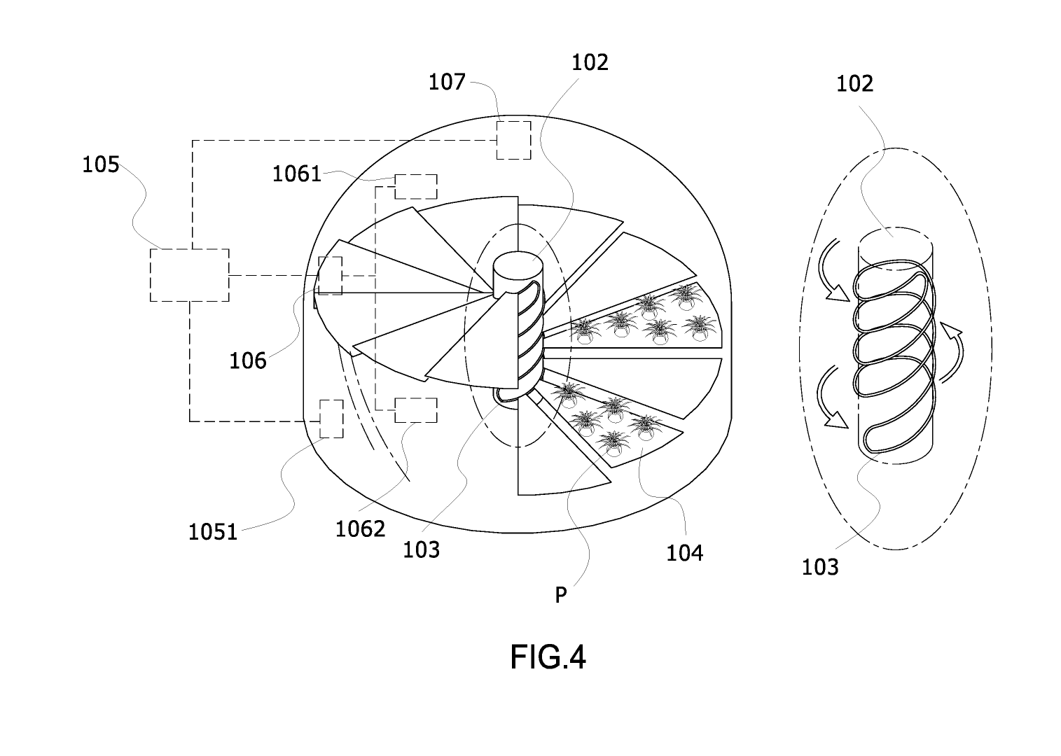

FIG. 3 is a flow chart showing the implementation of the invention. FIGS. 4 to 7 are schematic views showing the implementation of the invention. Referring to the drawings, the invention is implemented mainly according to the following steps.

In a control device enabling step 11, a user enables the control device 105 to further drive the rail module 103 so that the rail module 103 drives the supporting plate(s) 104 thereabove to circulate upwards and downwards around the supporting member 102 repeatedly.

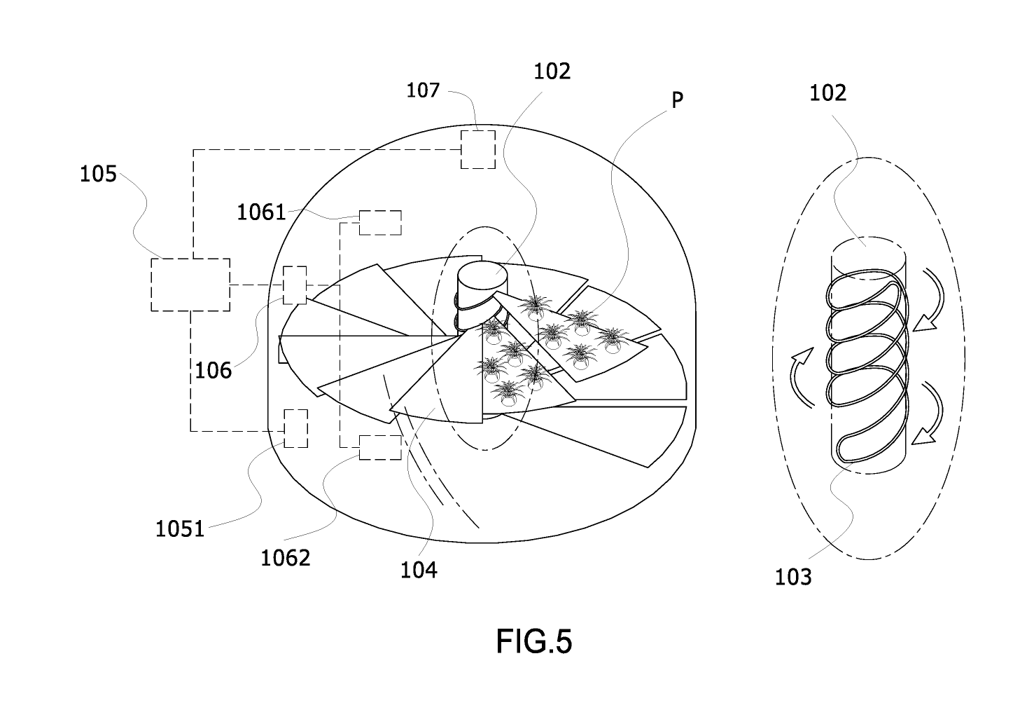

In a plant pot transporting step 12, the user places the to-be-cultivated plant pot(s) P on the supporting plate(s) 104, respectively, so that each plant pot P can be transported by the supporting plate 104. As shown in FIG. 4, the user firstly places the plant pot(s) P on the bottom layer of the rail module 103. When the plant pots P are transported by the supporting plate 104, they also circulate upwards along the supporting member 102 with the supporting plate 104. Referring again to FIG. 5, when the plant pots P are transported to the top end of the rail module 103, the plant pots P circulate downwards along the supporting member 102, and repeatedly circulate around the supporting member 102, so that each plant pot P can receive the sun light at each position.

In an environment state sensing step 13, after the control device 105 is enabled, the user can enable the sensing module 1051 to sense the environment state inside the cover body 101. Furthermore, the sensing module 1051 generates the environment state information S in the sensing process, and the sensing module 1051 transmits the environment state information S back to the control device 105.

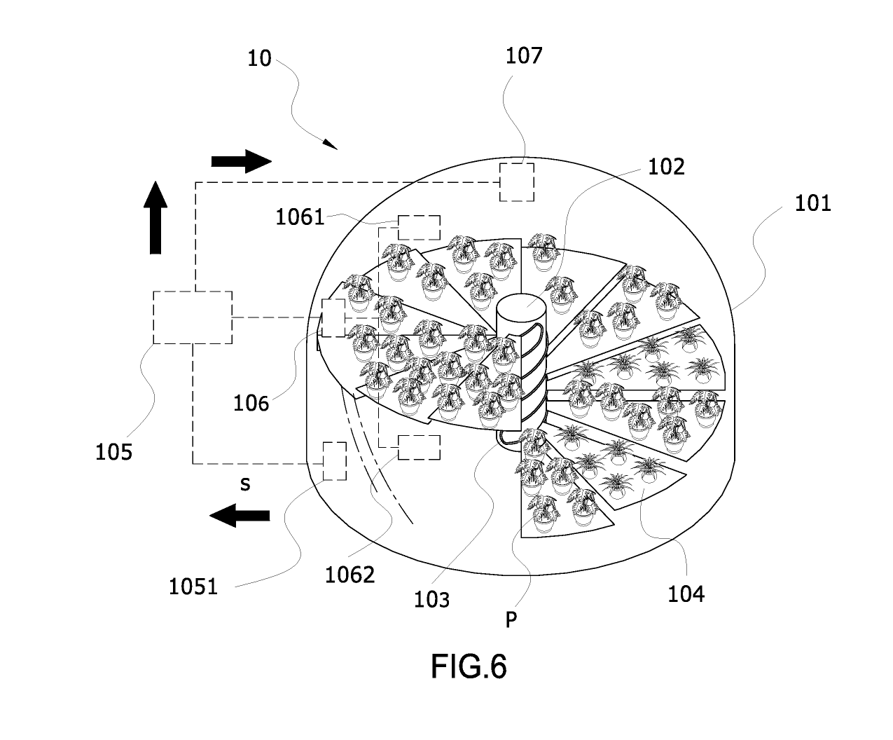

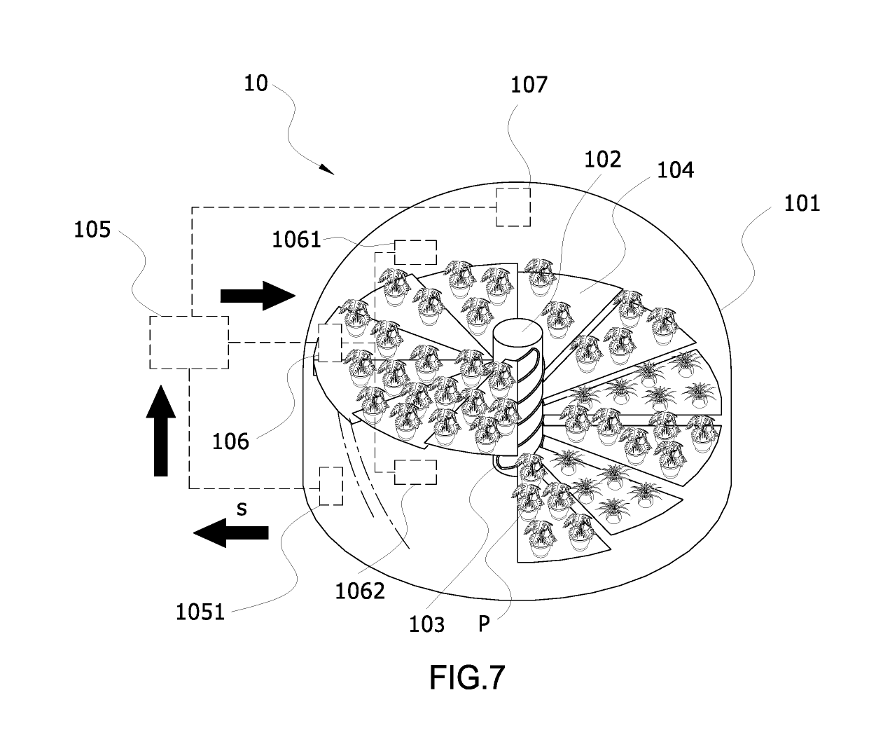

In a cultivating step 14, after the step 13, the control device 105 judges the environment state information S and performs the corresponding circulating operation so that the environment state in the cover body 101 becomes consistent and uniform. As shown in FIG. 6, when the sensing module 1051 senses the insufficient luminance (solar irradiance) inside the cover body 101, the control device 105 further enables the illumination device 107 to provide the supplemental optical energy for the plant pots P for optical reaction. As shown in FIG. 7, when the sensing module 1051 senses the insufficient humidity inside the cover body 101, the control device 105 enables the plant cultivating device 106 to spray and water the plant pots P to supplement the moisture.

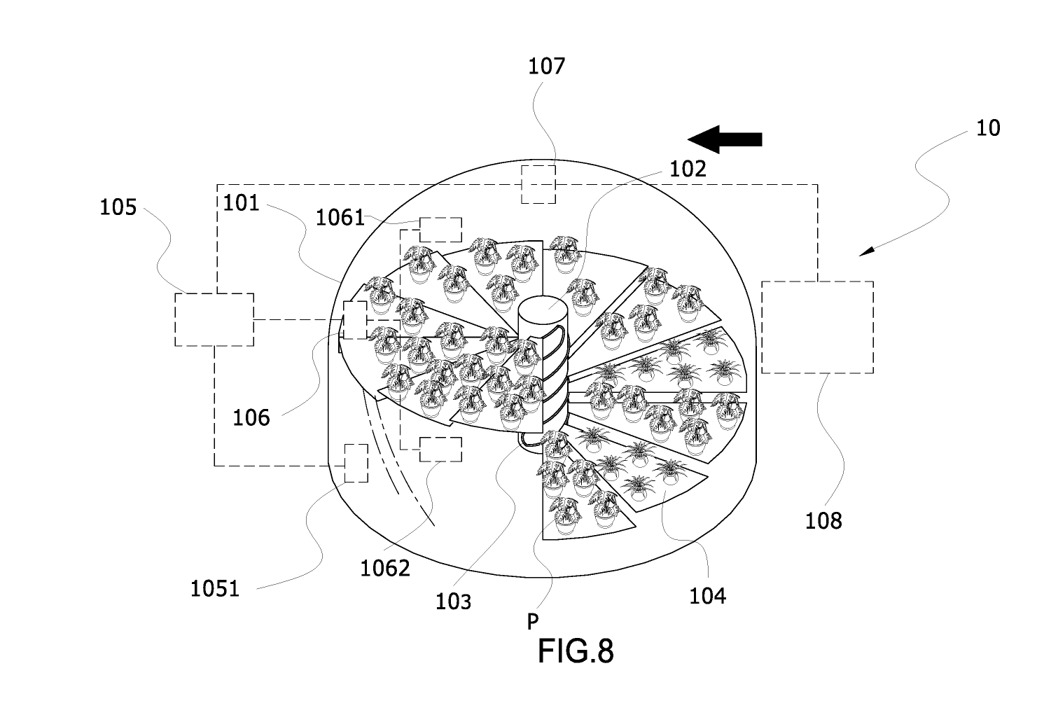

FIG. 8 shows another embodiment of the invention. Referring to FIG. 8, the illumination device 107 may be further electrically connected to an energy supply device 108, which may be a light-tracking solar panel, a geothermal power generating device, a water gas or the like, and may be disposed outside the cover body 101, or on the top end of the cover body 101. When the energy supply device 108 is disposed on the top end of the cover body 101, the energy supply device 108 may further block the too-strong light source to prevent the plants from being over-exposed. Upon implementation, the energy supply device 108 may convert a collected optical energy into an electrical energy for the illumination device 107 to effectively reduce the overall electricity consumption of the three-dimensional dynamic plant cultivating apparatus 10. Also, the energy supply device 108 may be electrically connected to an electricity storing device (not shown in this drawing). The electrical energy generated by the energy supply device 108 may be stored in the electricity storing device, which can provide the electric power to the associated devices (e.g., the rail module, control device, plant cultivating device, sensing module, illumination device and the like) in the three-dimensional dynamic plant cultivating apparatus 10. Furthermore, the energy supply device 108 may be electrically connected to a light source sensing module (not shown in this drawing). When the light source sensing module senses the insufficient light, the energy supply device 108 can supply the electrical energy of the electricity storing device to the illumination device 107 to lengthen the photosynthesis time of the crop.

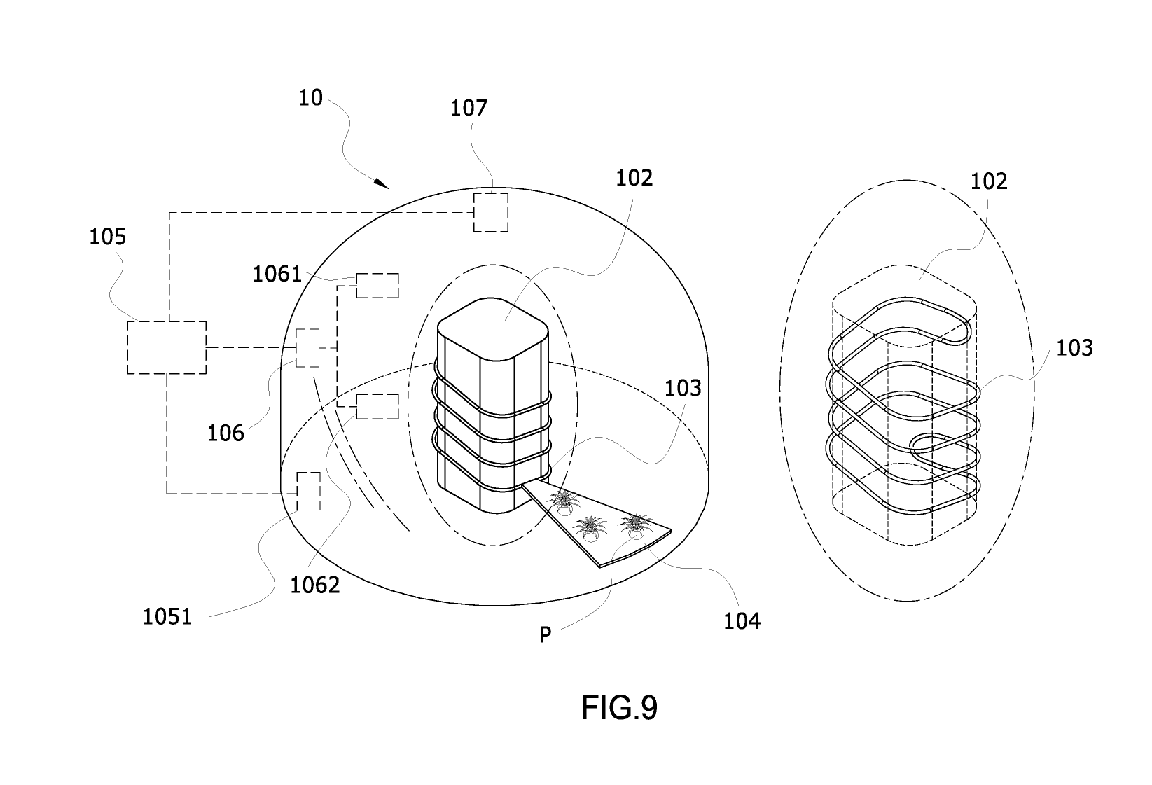

FIG. 9 shows still another embodiment of the invention. Referring to FIG. 9, the transportation route of the rail module 103 of the three-dimensional dynamic plant cultivating apparatus 10 may also be set according to the requirement. As shown in the drawing, the rail module 103 is disposed around the supporting member 102 in a rectangular manner. In another embodiment, the rail module 103 may also be disposed to circulate upwards and downwards around the supporting member 102. Thus, the transportation route of the plant pot P can be set by the rail module 103 according to the terrain conditions, so that the three-dimensional dynamic plant cultivating apparatus 10 can be implemented on the land that is not broad, and the application thereof can be significantly enhanced.

As mentioned hereinabove, it is obtained that the three-dimensional dynamic plant cultivating apparatus of the invention mainly has a plant pot placed on a supporting plate of a rail module, and a control device is used to drive the rail module so that the supporting plate circulates upwards and downwards around a supporting member repeatedly, and that the plant pot can receive the sufficient irradiation of a sun light source at various positions when being moved to facilitate the plant pot growth. Furthermore, the control device receives the environment state information sensed by a sensing module in a real-time manner, and then further enables the associated cultivating apparatus, such as the plant cultivating device or the illumination device, according to the environment state information. Thus, the timing-controlled, quantitative and automatic cultivation can be performed so that the growth environments of the plant pots become consistent. Furthermore, the three-dimensional dynamic plant cultivating apparatus of the invention has the airtight space to prevent the insect pest, has the automatic cultivation to reduce the manpower cost, and can avoid the artificial handling damage. Accordingly, the invention being implemented can indeed make the plant planted in the plant cultivating apparatus be subjected to the uniform irradiation, and further automatically control the peripheral cultivating apparatuses to achieve the object of providing a three-dimensional dynamic plant cultivating apparatus satisfying the timing-controlled and quantitative requirements. New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

In summary, the invention has the effects satisfying the utility, novelty and inventive step of the patentability requirements, and is thus filed as this utility patent application.

What is claimed is:

1. A three-dimensional dynamic plant cultivating apparatus for cultivating a plant pot and making the plant pot be subjected to overall irradiation of a sun light source, the three-dimensional dynamic plant cultivating apparatus comprising:
a cover body, which is transparent and arced, wherein the sun light source is incident to the cover body;
a supporting member standing in the cover body;
a rail module surrounding the supporting member, wherein supporting plates for supporting the plant pot are separately connected to the rail module; and
a control device, which is electrically connected to the rail module, and drives the rail module to move and operate, wherein
after the rail module is driven by the control device, each of the supporting plates repeatedly circulates upwards and downwards around the supporting member so that the plant pot is irradiated by the sun light source at various positions.

2. The three-dimensional dynamic plant cultivating apparatus according to claim 1, wherein a plant cultivating device is electrically connected to the control device and for watering, irrigating and fertilizing the plant pot, wherein the plant cultivating device comprises a watering and irrigating module and a fertilizing module.

3. The three-dimensional dynamic plant cultivating apparatus according to claim 1, wherein the control device has a sensing module for sensing an environment state inside the cover body and generating environment state information.

4. The three-dimensional dynamic plant cultivating apparatus according to claim 3, wherein the sensing module is selected from the group consisting of a humidity sensor, a brightness sensor and a temperature sensor.

5. The three-dimensional dynamic plant cultivating apparatus according to claim 1, wherein an illumination device is electrically connected to the control device, and for assisting in irradiating the plant pot.

6. The three-dimensional dynamic plant cultivating apparatus according to claim 5, wherein an energy supply device for generating an electrical energy is electrically connected to the control device.

7. The three-dimensional dynamic plant cultivating apparatus according to claim 6, wherein the energy supply device is selected from the group consisting of a light-tracking solar panel, a geothermal power generating device and a water gas.

8. The three-dimensional dynamic plant cultivating apparatus according to claim 1, wherein the rail module is disposed around the supporting member in a rectangular manner.

9. The three-dimensional dynamic plant cultivating apparatus according to claim 1, wherein the rail module circulates upwards and downwards around the supporting member.

10. An implementing method of a three-dimensional dynamic plant cultivating apparatus, comprising:
a control device enabling step of enabling a control device, driving a rail module, and making a supporting plate on the rail module repeatedly circulate upwards and downwards around a supporting member;
a plant pot transporting step of transporting a to-be-cultivated plant pot placed on the supporting plate;
an environment state sensing step, in which the control device enables a sensing module to sense an environment state inside a cover body of the three-dimensional dynamic plant cultivating apparatus and to generate environment state information, wherein the sensing module transmits the environment state information to the control device; and
a cultivating step performed after the environment state sensing step, wherein the control device judges the environment state information and further enables an illumination device and a plant cultivating device to make the environment state inside the cover body become uniform.
